(19) United States
(12) Patent Application Publication
(10) Pub. No.: US 2009/0296698 A1
(43) Pub. Date: Dec. 3, 2009

(54) DATA SWITCHING METHOD AND CIRCUIT

(75) Inventors: Mitsuru Sutou, Kawasaki (JP); Makoto Shimizu, Kawasaki (JP); Hiroshi Tomonaga, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/539,762

(22) Filed: Aug. 12, 2009

Related U.S. Application Data
(63) Continuation of application No. PCT/JP2007/052604, filed on Feb. 14, 2007.

(51) Int. Cl. H04L 12/50

(52) U.S. Cl. 370/382

(57) ABSTRACT

For restricting a scale increase of a switch device using a shared buffer, segments are received at input ports with each phase being shifted and are each composed of a predetermined length data in which each data is connected in series by a predetermined number. The segments are written in shared buffers at the same address in sequence for each segment, where the shared buffers are provided in parallel by the predetermined number. The address for each output port set in each segment is stored each time the writing is performed and the stored address is referred to in the sequence for each output port thereby to read each predetermined length data based on the address referred to from each shared buffer. Each predetermined length data read is connected in series and outputted to each output port.

### CROSS-REFERENCE TO RELATED APPLICATION

This application is a continuation of International Application PCT/JP2007/52604 filed on Feb. 14, 2007, the contents of which are herein wholly incorporated by reference.

### BACKGROUND

1. Field

The present invention relates to a data switching method and circuit in a switch device using a shared buffer.

2. Description of the Related Art

FIG. 6 shows an arrangement of an L2 switch device (hereinafter occasionally simply referred to as a switch device) using a shared buffer of related art. This switch device 1 is composed of n interface cards 2_0-2_{—}n and a switch card 4 connected in common to the cards 2_0-2_{—}n through ports P0-Pn.

When the interface cards 2_0-2_{—}n receive frames FR, destination information (abbreviated as info in the drawings) adding/deleting portions 3_0-3_{—}n inside the cards 2_0-2_{—}n respectively retrieve databases DB with destination addresses (not shown) set in the frames FR to acquire card information and port information (hereinafter referred to as destination information) of the frames to be transferred, and provide input signals IN having the destination information added to the frames FR to the ports P0-Pn of the switch card 4.

A switching circuit 5 inside the switch card 4 divides the input signals IN received respectively through the ports P0-Pn into segments (including the destination information) SG to be held in a shared buffer B500. At this time, the switching circuit 5 stores a hold address in the shared buffer B500 in an after-mentioned FIFO provided and managed for each port (hereinafter referred to as an output port) as a destination. Upon reading from the shared buffer B500, the switching circuit 5 acquires an address from the FIFO for each output port. At this time, the switching circuit 5 reads the segments SG from the shared buffer B500 at the acquired address for the recovery thereof and transfers them to the destination interface cards 2_0-2_{—}n as output signals OUT having the same format as the input signals IN.

Responsively, the destination information adding/deleting portions 3_0-3_{—}n inside the interface cards 2_0-2_{—}n respectively transfers the original frames FR having deleted therefrom the destination information added to the output signals OUT to the later stage.

A specific arrangement and operation of the switch card 4 in the switch device 1 will now be described referring to FIGS. 7-9.

### Related Art Example: FIGS. 7-9

FIG. 7 shows a related art example of the switching circuit 5 composing the switch card 4 together with the shared buffer B500, where for facilitating the description, the shared buffer B500 provided outside the switching circuit 5 is also shown by dotted lines in FIG. 7.

This switching circuit 5 is composed of an input portion 10 for storing input signals IN00-IN47, respectively received at 48 input ports PI00-PI47 (hereinafter occasionally represented by reference numeral PI), each having a data width of 32 bits as shown in clock converting FIFOs A100-A147 respectively; a shared buffer processor 20 for reading data of the input signals IN00-IN47 respectively from the FIFOs A100-A147 as divided into segments SG00-SG47 each having 32 data connected in series, and writing the segments SG00-SG47 in the shared buffer B500 to be read for each of output ports PO00-PO47 (hereinafter, occasionally generally referred to as a reference numeral PO) having a data width of 32 bits, thereby performing the switching process; a shared buffer address manager 30 for managing a write address WA and a read address RA with respect to the shared buffer B500 and providing the addresses WA and RA to the shared buffer processor 20; and an output portion 40 for once storing the segments SG switching-processed by the shared buffer processor 20 in clock converting FIFOs D100-D147 to be read for the recovery thereof and transmitting them to the output ports PO00-PO47 as output signals OUT00-OUT47.

### Writing Operation Example in Shared Buffer: FIGS. 7 and 8

At first, the input portion 10 writes the input signals IN00-IN47 received together with write enable signals WE through the input ports PI00-PI47 respectively in the clock converting FIFOs A100-A147. At this time, the clock converting FIFOs A100-A147 as thus written provide write complete pulses WP respectively to read address generators B100-B147 respectively connected to the FIFOs A100-A147 and forming the shared buffer processor 20.

When having received the above write completion pulses WP and a shared buffer write time slot signal (hereinafter occasionally referred to simply as time slot) TS_W generated by a write time slot generator B400, the read address generators B100-B147 provide read addresses RA_F to the clock converting FIFOs A100-A147, thereby reading segments SG00-SG47 to be provided to S/P (Serial/Parallel) converting circuits B200-B247.

It is to be noted that the above time slot TS_W is set with “0”, . . . , “47” being circulated as shown in FIG. 8. In this example, the read address generators B100-B147 are triggered by the reception of the time slot signals TS_W=“0”, . . . , “47” respectively to generate the read addresses RA_F, so that from the clock converting FIFOs A100-A147 the segments SG00-SG47 are read over 32 time slots from the points of the time slots TS_W indicating “1”, . . . , “47”, “0” respectively as shown, where the respective phases are mutually shifted by one time slot.

The S/P converting circuits B200-B247 convert 32 data D0-D31 (each having 32 bits) in series within the segments SG00-SG47 to 1024 bits in parallel to be provided to the multiplexer B300.

The multiplexer B300 selects one of the segments SG00-SG47 respectively inputted from the S/P converting circuits B200-B247 according to the time slot TS_W to be provided to the shared buffer B500. In this example, the multiplexer B300 selects the segments SG00-SG47 in sequence in synchronization with the completion timings of S/P conversion (time slots TS_W=“33”, . . . , “47”, “0”, . . . , “32”) of the S/P converting circuits B200-B247.

At the same, the multiplexer B300 provides a shared buffer write address output request RQ to a shared buffer write address FIFO C400 forming the shared buffer address manager 30 and extracts destination information DI set in the segment SG to be provided to a read address manager C500.

It is to be noted that the write address FIFO C400 has stored therein write null addresses of the shared buffer B500 and generates those null addresses as write addresses WA in sequence to be provided to the shared buffer B500 at every reception of the address output request RQ, whereby the segments SG are written at the addresses WA of the shared buffer B500 as shown by dotted lines (1) in FIG. 8.

The write address WA outputted from the shared buffer write address FIFO C400 is also provided to the read address manager C500 at the same phase as the destination information DI, so that the read address manager C500 stores the write address WA in one of the shared buffer read address FIFOs C100-C147 provided corresponding to the output ports PO00-PO47 depending on the destination information DI.

Reading Operation Example from Shared Buffer: FIGS. 7 and 9

On the other hand, upon reading from the shared buffer B500, a read address selector C300 having received a shared buffer read time slot signal TS_R from a read time slot generator C200 obtains a read address RA from one of the shared buffer read address FIFOs C100-C147 in accordance with the time slot signal TS_R to be provided to the shared buffer B500. At the same time, the read address selector C300 stores the obtained read address RA in the shared buffer read address FIFO C400, whereby the read address RA is to be used as the write null address for the following writing operations in the shared buffer B500.

It is to be noted that the above time slot TS_R is set with “0”, . . . , “47” being circulated as shown in FIG. 9. In this example, the read address selector C300 makes the time slots TS_W=“1”, . . . , “47”, “0” a trigger for acquiring the addresses RA for the read address FIFOs C100-C147 and so acquires the addresses RA in sequence from the read address FIFOs C100-C147 to be provided to the shared buffer B500, whereby the segments SG corresponding to the output ports PO00-PO47 are read in sequence from the read addresses RA of the shared buffer B500 to be provided to a demultiplexer B600.

The demultiplexer B600 selects the output destination of the segments depending on the time slot TS_R such that a P/S converting circuit B700 is selected and provided with the segment SG when the time slot TS_W indicates “2”, a P/S converting circuit B701 is selected and provided with the segment SG when the time slot TS_R indicates “3”, . . . , a P/S converting circuit B746 is selected and provided with the segment SG when the time slot TS_R indicates “0”, and a P/S converting circuit B747 is selected and provided with the segment SG when the time slot TS_R indicates “1”.

The P/S converting circuits B700-B747 convert the segments SG (each 1024 bits) in parallel to 32 data D0-D31 (each 32 bits) in series to be provided to the clock converting FIFOs D100-D147 as shown by dotted lines (2) in FIG. 9, whereby the output signals OUT00-OUT47 are transmitted from the output ports PO00-PO47, respectively.

Thus, the switching circuit 5 enables the input signals IN inputted from the input ports PI to be switched to a desirable output port PO.

For reference, the following examples (1) and (2) are mentioned:

### Reference Example (1)

A time division switching circuit in which S/P converted input data are sequentially written in a memory and then the data are read at random from the memory and P/S converted, whereby making a channel switching of the input signal (See, e.g. Japanese patent application publication No. 04-130896).

### Reference Example (2)

A time slot switching circuit in which the order of n channel signals made by dividing a data signal over a period of one bit is changed with a memory (See, e.g. Japanese patent application publication No. 03-201734).

The related art shown in FIGS. 7-9 is disadvantage in that while both of the S/P converting circuits and the P/S converting circuits are employed to perform the switching process, these circuits include flip-flop circuits increasing in number depending on a bit width for conversion, so that the scale of the switch device is increased.

Namely, in the example shown in FIG. 7, the S/P converting circuits B200-B247 perform S/P conversions respectively from 32 bits to 1024 bits, where the number of the flip-flop circuits required by the S/P converting circuits B200-B247 is 1024 as shown in FIG. 10, and similarly the number of the flip-flop circuits required when the P/S converting circuits B700-B747 perform P/S conversions respectively from 1024 bits to 32 bits is also 1024, so that a total of 98304 {(1024×48)×2} flip-flop circuits are required.

### SUMMARY

It is accordingly an object of the present invention to provide a data switching method and circuit in which a scale increase of a switch device using a shared buffer is restricted.

[1] In order to achieve the above-mentioned object, there is provided a data switching method (or circuit) comprising: a first step of (or means) writing each data of a predetermined length data, in which each data is connected in series by a predetermined number, forming each of segments received at input ports with each phase being shifted in shared buffers at a same address in sequence for each segment, the shared buffers being provided in parallel by the predetermined number; a second step of (or means) storing the address for each output port set in each segment each time the writing is performed; a third step of (or means) referring to the stored address in the sequence for each output port thereby to read each data of the predetermined length data in the sequence from each shared buffer based on the address referred to; and a fourth step of (or means) connecting each data of the predetermined length data read in series to be outputted to each output port.

Thus, the above data switching method (or circuit) enables a switching process to be made without using a S/P conversion and a P/S conversion for the segments.

[2] Also, in the above [1], the first step (or means) may comprise: a step of (or means) separating each segment into each data of the predetermined length data in parallel for each input port; a step of (or means) multiplexing the separated data of the predetermined length data from each input port to be provided to each shared buffer; a step of (or means) generating a write null address common to the shared buffers each time each segment is inputted to any one of the input port; and a step of (or means) providing the write null address to each shared buffer in synchronization with a phase of the multiplexed data, thereby enabling each data of the predetermined length data of each segment to be written in the same address of each shared buffer.
[3] Also, in the above [1], the third step (or means) may comprise a step of (or means) providing a phase of the address referred to for each output port to each shared buffer with the phase being shifted corresponding to the sequence thereby to read each data of the predetermined length data from each shared buffer with the phase being shifted corresponding to the sequence and a step of (or means) separating each data of the predetermined length data read for each shared buffer for each output port; and the fourth step (or means) may comprise a step of (or means) multiplexing the separated data from each shared buffer to be provided to each output port.

As in the above [2] and [3], arrangements on the writing side and the reading side of the shared buffer can be made of a simple structure.

[4] Also, in the above [1], the third step (or means) may comprise a step of (or means) providing a phase of the address referred to for each output port to each shared buffer with the phase being shifted corresponding to the sequence between groups of the shared buffers divided based on a data width of each output port thereby to read each data of the predetermined length data from each shared buffer with the phase being shifted corresponding to the sequence between the groups and a step of (or means) separating each data of the predetermined length data read for each group of the shared buffers for each output port; and the fourth step (or means) may comprise a step of (or means) multiplexing the separated data from each group of the shared buffers to be provided to each output port.

Namely, in this case, it becomes possible to perform the switching process depending on various data widths of output ports.

According to the above switching method (or circuit), the number of flip-flop circuits included in a S/P converting circuit and a P/S converting circuit is reduced to suppress the increase of the scale of the switch device, thereby enabling the switch device to be small-sized and reduced in power consumption.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an arrangement in an embodiment [1] of a data switching method and circuit;

FIG. 2 is a time chart showing a writing operation example in a shared buffer in an embodiment [1] of a data switching method and circuit;

FIG. 3 is a time chart showing a reading operation example from a shared buffer in an embodiment [1] of a data switching method and circuit;

FIG. 4 is a block diagram showing an arrangement in an embodiment [2] of a data switching method and circuit;

FIG. 5 is a time chart showing a reading operation example from a shared buffer in an embodiment [2] of a data switching method and circuit;

FIG. 6 is a block diagram showing an arrangement of an L2 switch device of related art;

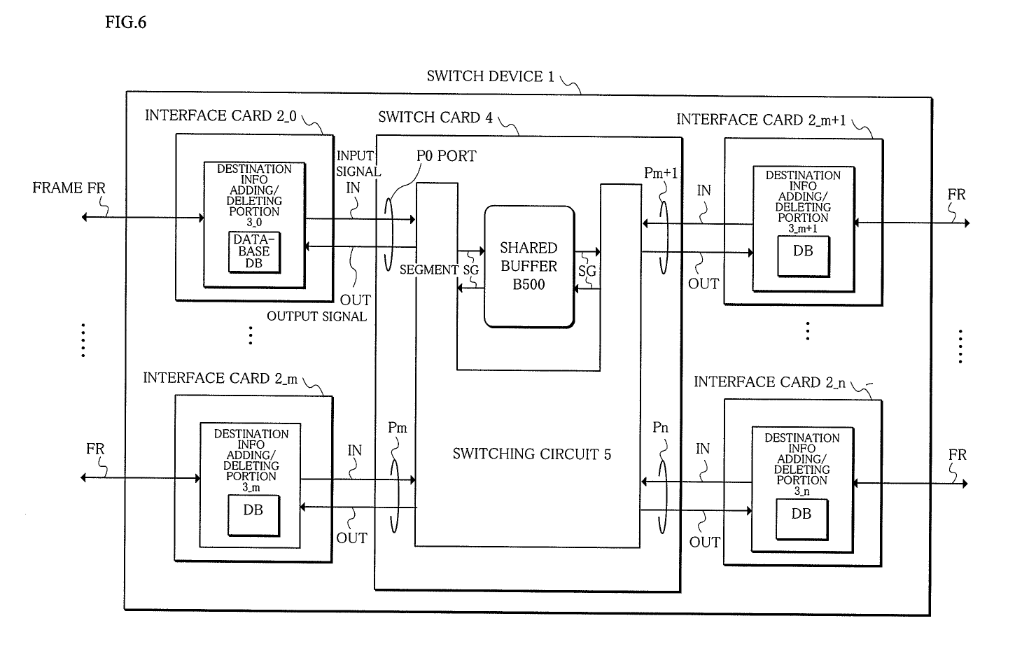

FIG. 7 is a block diagram showing an arrangement of a switching circuit of related art;

FIG. 8 is a time chart showing a writing operation example in a shared buffer of a related art switching circuit;

FIG. 9 is a time chart showing a reading operation example from a shared buffer of a related art switching circuit; and

FIG. 10 is a graph showing the number of flip-flop circuits included in a S/P converting circuit.

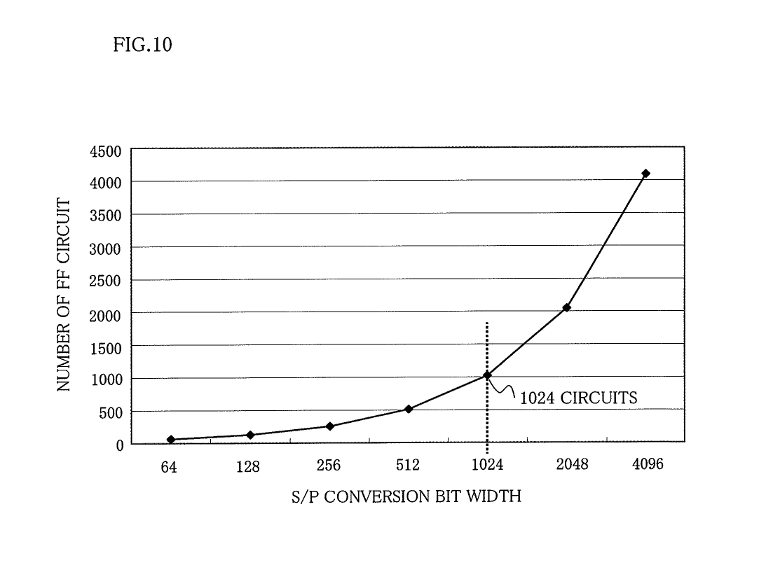

### DESCRIPTION OF THE EMBODIMENTS

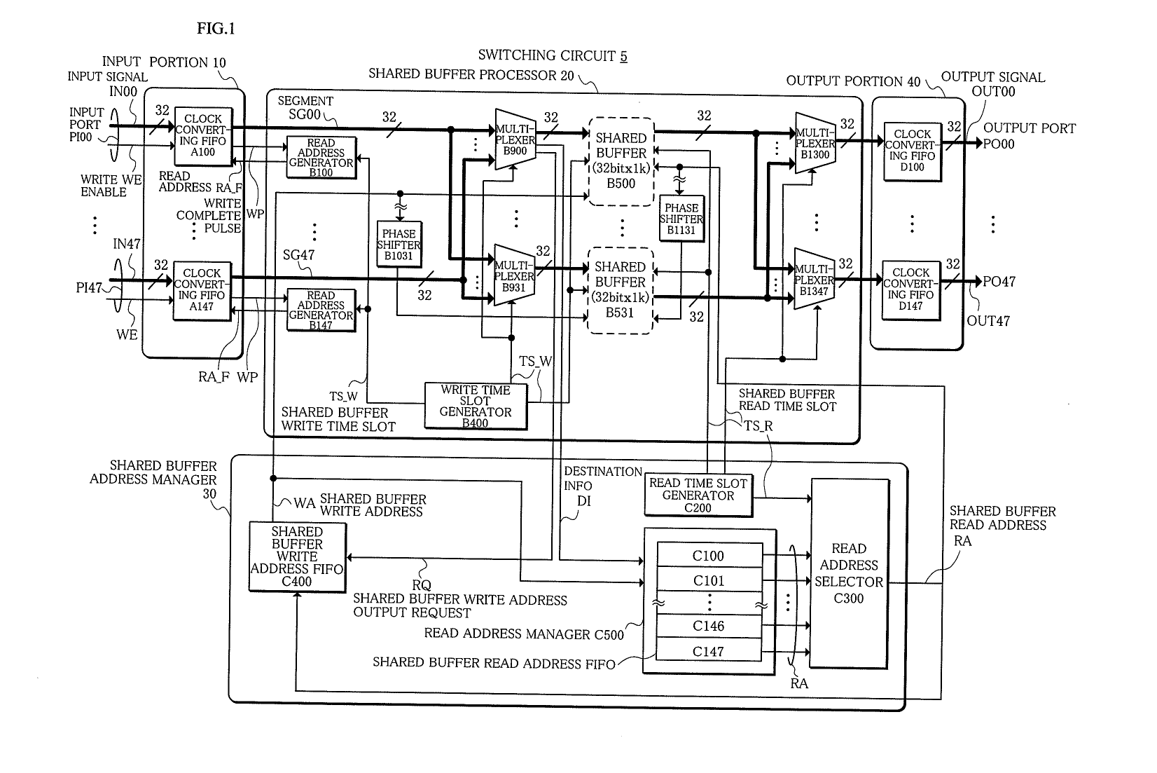

Embodiments [1] and [2] according to a data switching method and a circuit using the method will now be described referring to FIGS. 1-5 as follows.

### Embodiment [1]

### FIGS. 1-3

### Arrangement: FIG. 1

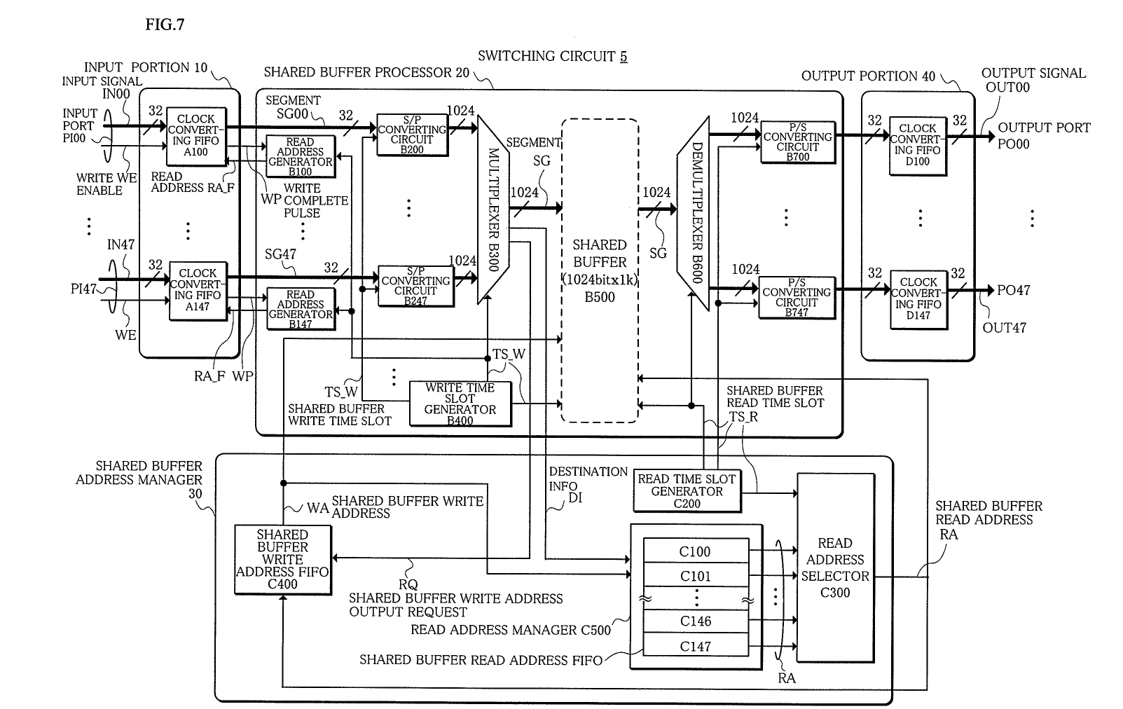

A switching circuit 5 according to an embodiment [1] shown in FIG. 1 is different from the related art shown in FIG. 7 in that the former comprises 32 shared buffers B500-B531 provided in parallel to conform to a serially connected number (32) of 32 bit data in the segments SG; multiplexers B900-B931 for multiplexing the segments SG00-SG47 for each shared buffer in response to the write time slot signal TS_W to be provided respectively to the shared buffers B500-B531; phase shifters B1001-B1031 for shifting the phase of the write address WA outputted from the shared buffer write address FIFO C400 in synchronization with the phases of the data outputted from the multiplexers B900-B931 to be provided respectively to the shared buffers B500-B531; phase shifters B1101-B1131 for shifting the phase of the read address RA outputted from the read address selector C300 in accordance with the sequence of the phase shift for the write address WA by the phase shifters B1001-B1031 to be provided respectively to the shared buffers B500-B531; and multiplexers B1300-B1347 for multiplexing the data read respectively from the shared buffers B500-B531 for each output port in synchronization with the read time slot signal TS_R to be provided respectively to the clock converting FIFOs D100-D147.

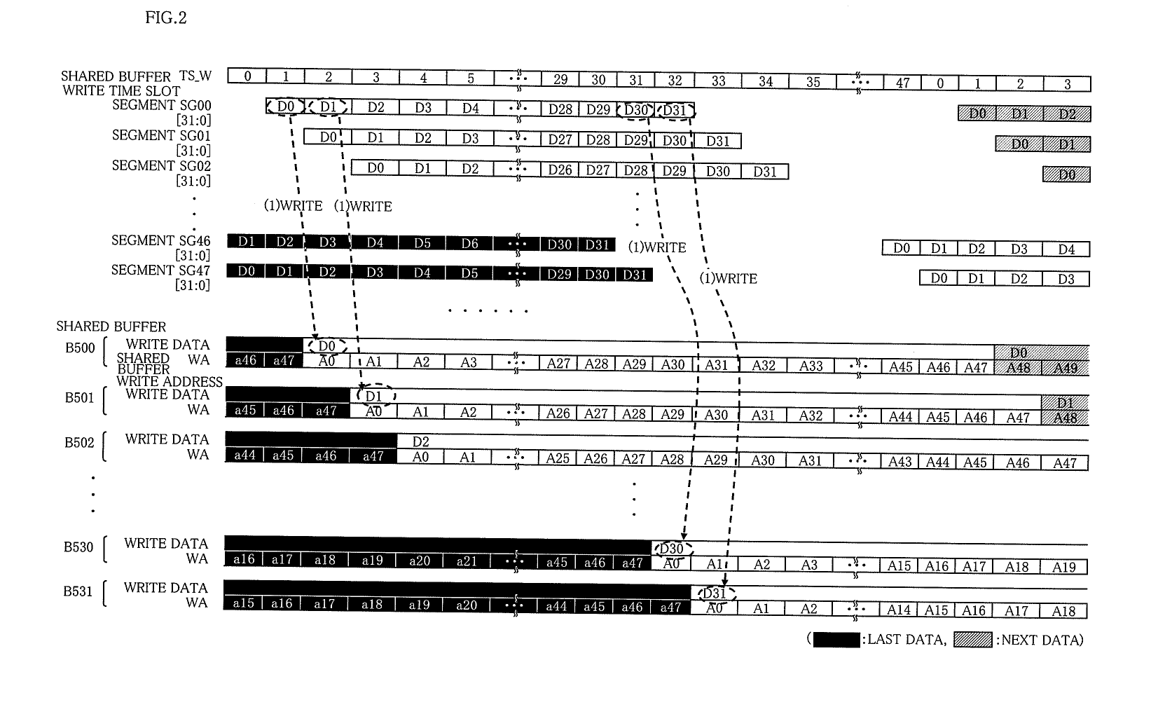

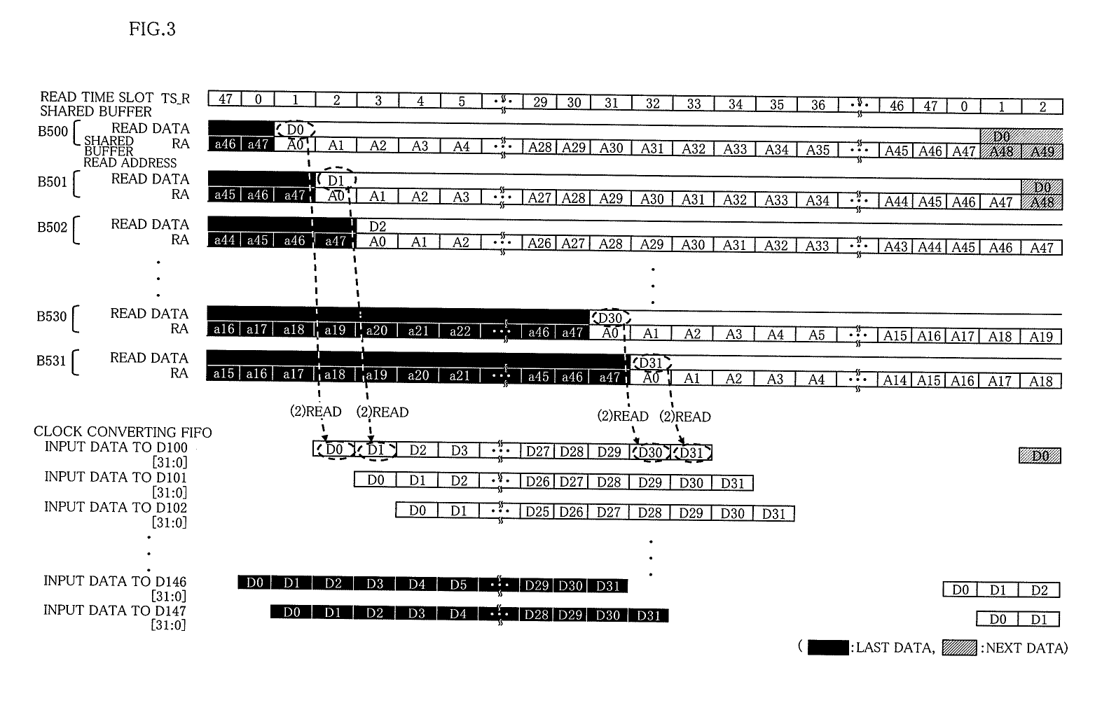

### Operation Example: FIGS. 2 and 3

Next, an operation of this embodiment will be described, where at first a writing operation in the shared buffers B500-B531 will be described referring to FIG. 2 and then a reading operation from the shared buffers B500-B531 will be described referring to FIG. 3.

### Writing Operation Example in Shared Buffers: FIG. 2

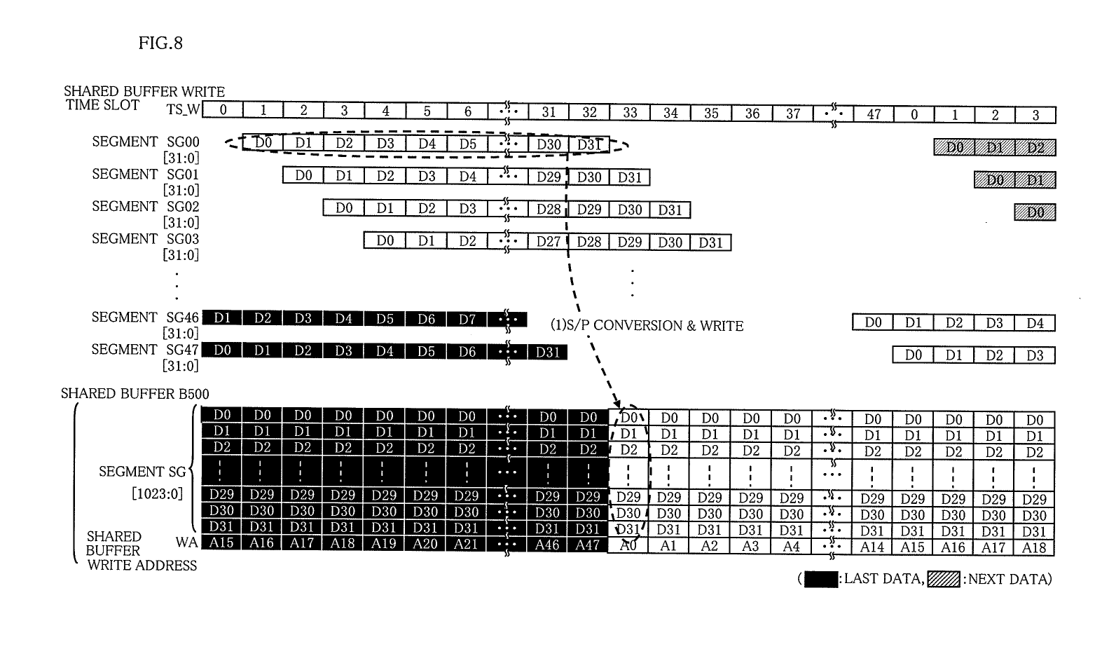

As shown in FIG. 2, the input signals IN00-IN47 received at the input ports PI00-PI47 are provided to the shared buffer processor 20 by the segments SG00-SG47 whose phases are mutually shifted by one time slot due to the mutual action between the clock converting FIFOs A100-A147 and the read address generators B100-B147 as with FIG. 8.

Taking the segment SG00 as an example, the multiplexer B900 inside the shared buffer processor 20 provides the data D0 from the clock converting FIFO A100 to the shared buffer B500 when the shared buffer write time slot TS_W indicates “1”. The multiplexers B901-B931 select the data D1-D31 from the clock converting FIFO A100 when the time slots TS_W respectively indicate “2”, . . . , “32” and provide them to the shared buffers B501-B531. At this time, the multiplexer B900 having received the head data D0 in the segment SG00 detects the fact that the segment SG corresponding to one of the input ports PI00-PI47 has been newly provided, gives the shared buffer write address output request RQ to the shared buffer write address FIFO C400 and extracts the destination information DI, set in the data D0, to be provided to the read address manager C500.

The write address WA=“A0” outputted from the write address FIFO C400 is first provided to the shared buffer B500 at the same phase (time slot TS_W=“2”) as the data D0, so that the data D0 is first written at the address “A0” of the shared buffer B500. The phase shifters B1001-B1031 shift in sequence the phase of the write address WA, in synchronization with the time slots TS_W=“3”, . . . , “33” of the next stage, to be provided to the shared buffers B501-B531 at the same phase (time slots TS_W=“3”, . . . , “33”) as the data D1-D31.

This enables the data D1-D3 to be written in sequence at the address “A0” of the shared buffers B501-B531 as shown by dotted lines (1) in FIG. 2.

As for the segments SG01-SG47, the data are selected according to the time slots TS_W such that the data D0-D31 from the clock converting FIFO A101 are selected when the time slots TS_W respectively indicate “2”, . . . , “33”, the data D0-D31 from the clock converting FIFO A102 are selected when the time slots TS_W respectively indicate “3”, . . . , “34”, . . . and the data D0-D31 from the clock converting FIFO A147 are selected when the time slots TS_W respectively indicate “0”, . . . , “31”.

Also, the phase shifters B1001-B1031 shift the phases of the write addresses A=“A0”-“A47” outputted from the write address FIFO C400 as in the above, whereby the data D0-D31 in the segments SG01-SG47 are written in sequence at the same addresses “A1”-“A47” corresponding to the segments SG01-SG47 in the shared buffers B500-B531.

Reading Operation Example from Shared Buffers: FIG. 3

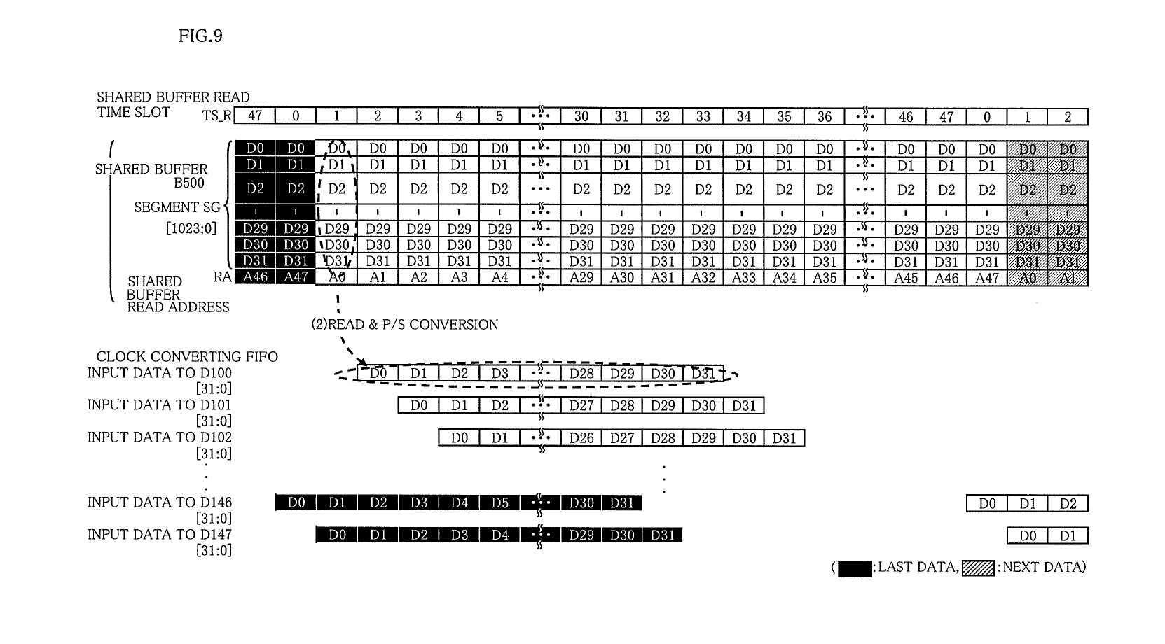

As shown in FIG. 3, the read address selector C300 receives, like FIG. 9, the shared buffer read time slots TS_R=“1”, . . . , “47”, “0” as a trigger of acquiring the shared buffer read address RA with respect to the shared buffer read address FIFOs C100-C147, thereby acquiring in sequence the read addresses RA=“A0”-“A47” from the read address FIFOs C100-C147 to be provided to the shared buffer B500. At this time, the phase shifters B1101-B1131 shift the phases of the read addresses RA=“A0”-“A47” respectively in synchronization with the time slots TS_R={“2”, . . . , “32”}, {“3”, . . . , “33”} . . . , and {“1”, . . . , “31”} of the next stage and provide them to the shared buffer B501-B531.

Thus, the data D0-D31 are read from the addresses “A0”-“A47” in the shared buffers with the phases being shifted by one time slot in accordance with the write sequence described in the above write operation example.

Taking a case where the data D0-D31 are read from the address “A0” of the shared buffers B500-B531 as shown by dotted lines (2) in FIG. 3 as an example, the multiplexer B1300 provides the data D0-D31 to the clock converting FIFO D100 in sequence when the time slots TS_R respectively indicate “1”, . . . , “32”, whereby the output signal OUT00 having the same format as the input signal IN is to be transmitted through the output port PO00.

As for the data D0-D31 read from the addresses “A1”-“A47” in the shared buffers B500-B531, the multiplexers B1300-B1347 select the destinations of the data in response to the time slots TS_R such that the data D0-D31 are provided to the clock converting FIFO D101 when the time slots TS_R respectively indicate “2”, . . . , “33”, the data D0-D31 are provided to the clock converting FIFO D102 when the time slots TS_R respectively indicate “3”, . . . , “34”, . . . and the data D0-D31 are provided to the clock converting FIFO D147 when the time slots TS_R respectively indicate “0”, . . . , “31”, whereby the output signals OUT01-OUT47 are to be transmitted respectively through the output ports PO01-PO47.

Thus, the switching circuit 5 of this embodiment performs the switching process without using any S/P converting circuit and P/S converting circuit, thereby decreasing approximately 98300 flip-flop circuits as compared with the related art shown in FIG. 7.

It is to be noted that while the phase shifters B1001-B1031 and B1101-B1031 may respectively include one flip-flop circuit, totaling to the extent of several tens of flip-flop circuits, the number of these flip-flop circuits is fairly small as compared with the number of flip-flop circuits included in the S/P converting circuits and the P/S converting circuits, rarely affecting the mounting area and the power consumption of the switching circuit 5 in its entirety. Also, the 32 shared buffers B500-B531 may respectively include flip-flop circuits, whereas the total capacity of the shared buffers B500-B531 of this embodiment assumes 1 Mbits {(32 bits×1 k)×32} shown in FIG. 1, that is the same as the capacity (1 Mbits(1024 bits×1 k)) of the shared buffer B500 of the related art shown in FIG. 7, so that the number of flip-flop circuits in the switching circuit 5 is not increased.

### Embodiment [2]

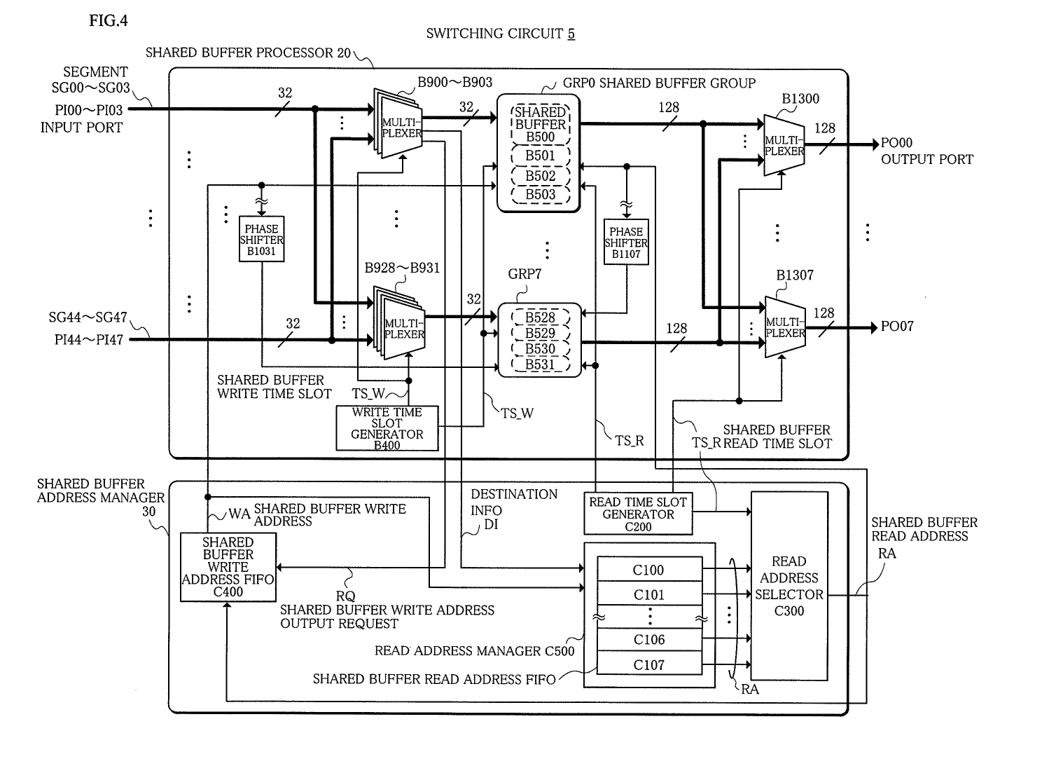

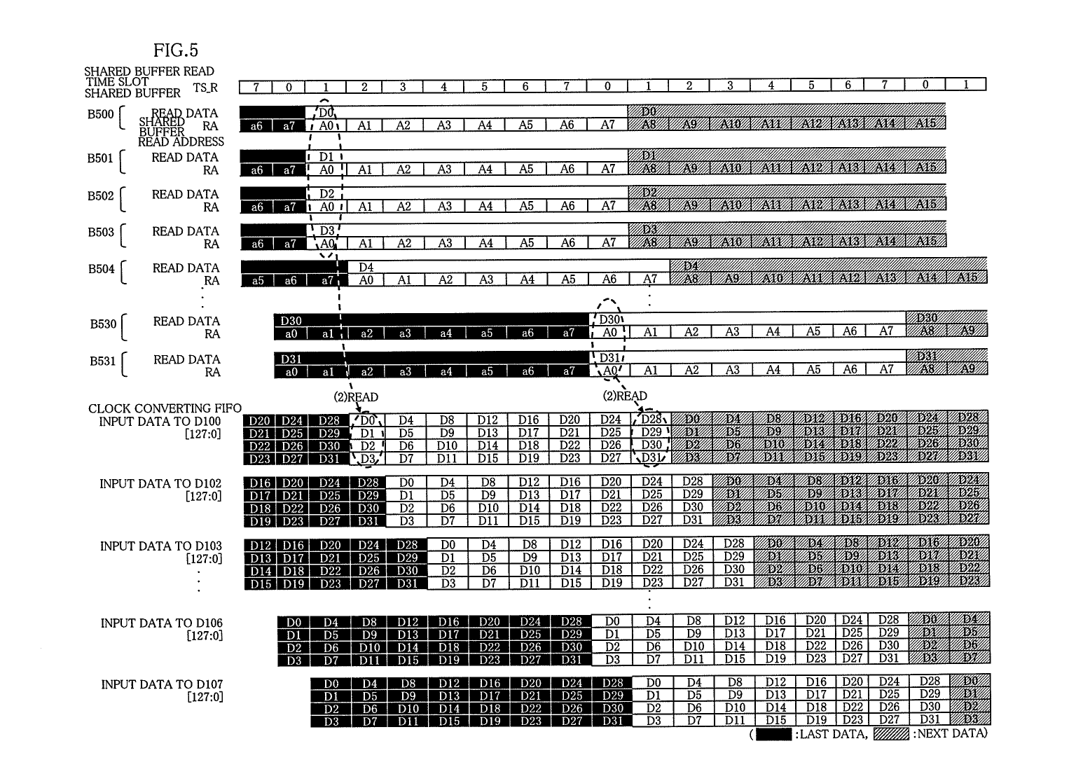

### FIGS. 4 and 5

A switching circuit 5 according to an embodiment [2] shown in FIG. 4 is different from the one in the above embodiment [1] in that there are provided eight output ports PO00-PO07 each having a data width of 128 bits, in accordance with which the shared buffers B500-B531 are divided into eight groups GRP0-GRP7 each having four shared buffers (32 bits×4).

Also, the shared buffer processor 20 comprises phase shifters B1101-B1107 for shifting the phases of the shared buffer read addresses RA in sequence between the groups GRP0-GRP7, and multiplexers B1300-B1307 provided corresponding to the groups GRP0-GRP7.

Furthermore, the number of read address FIFOs managed by the read address manager C500 inside the shared buffer address manager 30 is modified to 8 (C100-C107) corresponding to the number (8) of the output ports.

It is to be noted that for the simplification of the figures, the depiction of the input portion 10, read address generators B100-B147 inside the shared buffer processor 20 and the output portion 40 are hereby omitted.

Next, an operation of this embodiment will be described, where the description of the writing operation in the shared buffers B500-B531 is omitted because it is similar to the above embodiment [1], so that only a reading operation from the shared buffers B500-B531 will be described referring to FIG. 5 as follows:

As shown in FIG. 5, when the shared buffer read time slots TS_R set with “0”, . . . , “7” being circulated indicate “1”, . . . , “7”, “0” respectively, the read address selector C300 acquires the read addresses RA=“A0”-“A7”, respectively from the shared buffer read address FIFOs C100-C107, to be provided to the shared buffers B500-B531 within the shared buffer group GRP0 at the same phase.

At this time, the phase shifters B1101-B1107 provide the phases of the read addresses RA=“A0”-“A7” to the shared buffer groups GRP1-GRP7 with the phases being shifted in sequence in conformity with time slots TS_R={“2”, . . . , “7”, “0”}, {“3”, . . . , “7”, “0”, “1”}, . . . , and {“1”, . . . , “7”} of the next stage, respectively.

Thus, the data D0-D31 are read in parallel from the addresses “A0”-“A7” of the shared buffers with the phases being shifted by one time slot according to the writing sequence described in the above embodiment [1] between the shared buffer groups GRP0-GRP7.

Taking a case where the data D0-D31 are read from the address “A0” of the shared buffers B500-B531 as an example, the multiplexers B1300-B1307 provide parallel data D0-D3, D4-D7, . . . , and D28-D31 of 128 bits to the clock converting FIFO D100 in sequence when the time slots TS_R respectively indicate “1”, . . . , “7”, “0”, whereby the output signal OUT00 of the bit width “128 bits” is to be transmitted through the output port PO00.

As for the data D0-D31 read from the addresses “A1”-“A47” of the shared buffers B500-B531, the multiplexers B1300-B1307 select one of the clock converting FIFOs D100-D107 for output destinations of the parallel data D0-D3, D4-D7, . . . , and D28-D31 in accordance with the time slots TS_R, whereby the output signals OUT01-OUT47 of the bit width=“128 bits” are to be transmitted through the output ports PO01-PO47, respectively.

It is also to be noted that the present invention is not limited by the above-mentioned embodiments, and it is obvious that various modifications may be made by one skilled in the art based on the recitation of the claims.

1. A data switching method comprising:
a first step of writing each data of a predetermined length data, in which each data is connected in series by a predetermined number, forming each of segments received at input ports with each phase being shifted in shared buffers at a same address in sequence for each segment, the shared buffers being provided in parallel by the predetermined number;
a second step of storing the address for each output port set in each segment each time the writing is performed;
a third step of referring to the stored address in the sequence for each output port thereby to read each data of the predetermined length data in the sequence from each shared buffer based on the address referred to; and
a fourth step of connecting each data of the predetermined length data read in series to be outputted to each output port.

2. The data switching method as claimed in claim 1, wherein the first step comprises:
a step of separating each segment into each data of the predetermined length data in parallel for each input port;
a step of multiplexing the separated data of the predetermined length data from each input port to be provided to each shared buffer;
a step of generating a write null address common to the shared buffers each time each segment is inputted to any one of the input port; and
a step of providing the write null address to each shared buffer in synchronization with a phase of the multiplexed data, thereby enabling each data of the predetermined length data of each segment to be written in the same address of each shared buffer.

3. The data switching method as claimed in claim 1, wherein
the third step comprises a step of providing a phase of the address referred to for each output port to each shared buffer with the phase being shifted corresponding to the sequence thereby to read each data of the predetermined length data from each shared buffer with the phase being shifted corresponding to the sequence and a step of separating each data of the predetermined length data read for each shared buffer for each output port; and
the fourth step comprises a step of multiplexing the separated data from each shared buffer to be provided to each output port.

4. The data switching method as claimed in claim 1, wherein
the third step comprises a step of providing a phase of the address referred to for each output port to each shared buffer with the phase being shifted corresponding to the sequence between groups of the shared buffers divided based on a data width of each output port thereby to read each data of the predetermined length data from each shared buffer with the phase being shifted corresponding to the sequence between the groups and a step of separating each data of the predetermined length data read for each group of the shared buffers for each output port; and
the fourth step comprises a step of multiplexing the separated data from each group of the shared buffers to be provided to each output port.

5. A data switching circuit comprising:
a first means writing each data of a predetermined length data, in which each data is connected in series by a predetermined number, forming each of segments received at input ports with each phase being shifted in shared buffers at a same address in sequence for each segment, the shared buffers being provided in parallel by the predetermined number;
a second means storing the address for each output port set in each segment each time the writing is performed;
a third means referring to the stored address in the sequence for each output port thereby to read each data of the predetermined length data in the sequence from each shared buffer based on the address referred to; and
a fourth means connecting each data of the predetermined length data read in series to be outputted to each output port.

6. The data switching circuit as claimed in claim 5, wherein the first means comprises:
a means separating each segment into each data of the predetermined length data in parallel for each input port;
a means multiplexing the separated data of the predetermined length data from each input port to be provided to each shared buffer;
a means generating a write null address common to the shared buffers each time each segment is inputted to any one of the input port; and
a means providing the write null address to each shared buffer in synchronization with a phase of the multiplexed data, thereby enabling each data of the predetermined length data of each segment to be written in the same address of each shared buffer.

7. The data switching circuit as claimed in claim 5, wherein
the third means comprises a means providing a phase of the address referred to for each output port to each shared buffer with the phase being shifted corresponding to the sequence thereby to read each data of the predetermined length data from each shared buffer with the phase being shifted corresponding to the sequence and a means separating each data of the predetermined length data read for each shared buffer for each output port; and
the fourth means comprises a means multiplexing the separated data from each shared buffer to be provided to each output port.

8. The data switching circuit as claimed in claim 5, wherein
the third means comprises a means providing a phase of the address referred to for each output port to each shared buffer with the phase being shifted corresponding to the sequence between groups of the shared buffers divided based on a data width of each output port thereby to read each data of the predetermined length data from each shared buffer with the phase being shifted corresponding to the sequence between the groups and a means separating each data of the predetermined length data read for each group of the shared buffers for each output port; and
the fourth means comprises a means multiplexing the separated data from each group of the shared buffers to be provided to each output port.
